(19) United States
(12) Patent Application Publication
(10) Pub. No.: US 2022/0207586 A1
(43) Pub. Date: Jun. 30, 2022

(54) ECOMMERCE AGGREGATION PLATFORM

(71) Applicant: Leah Soiefer, Short Hills, NJ (US)

(72) Inventor: Leah Soiefer, Short Hills, NJ (US)

(21) Appl. No.: 17/552,456

(22) Filed: Dec. 16, 2021

Related U.S. Application Data
(60) Provisional application No. 63/132,312, filed on Dec. 30, 2020.

(51) Int. Cl. G06Q 30/06; G06Q 10/06; G06Q 30/02; G06F 9/54

(52) U.S. Cl. CPC G06Q 30/0629; G06Q 30/0613; G06Q 30/0643; G06Q 30/0605; G06Q 10/087; G06Q 30/0633; G06Q 30/0201; G06F 9/541; G06Q 10/06314

(57) ABSTRACT

A system is described herein. The system includes a merchant server hosting a marketplace service and a computing device. The marketplace service is configured to access a first website housing products and a second website housing products, perform an acquisition operation to extract information about a first product of the products from the first website and from the second website, and aggregate the information about the first product into a comparison format. A marketplace application of the computing device allows the user to access the marketplace service. The marketplace application transmits a request received from the user for the information associated with the first product to the marketplace service, where the marketplace service executes the request and displays the comparison format of the information for the first product to the user via a graphical user interface (GUI) of the computing device.

### CROSS-REFERENCE TO RELATED APPLICATIONS SECTION

This application is a U.S. Non-Provisional patent application that claims priority to U.S. Provisional Patent Application Ser. No. 63/132,312 filed on Dec. 30, 2020, the entire contents of which are hereby incorporated by reference in their entirety.

### FIELD OF THE EMBODIMENTS

The field of the invention and its embodiments relate to an e-commerce aggregation platform. In particular, the field of the invention and its embodiments relate to a web-based comparison shopping and marketplace service that enables a user to search for and browse products and compare information associated with the products from different websites.

### BACKGROUND OF THE EMBODIMENTS

Advances in data networking technologies have given rise to web-based retail stores and marketplaces. The nature and variety of these online stores and marketplaces is diverse. Online stores and marketplaces allow customers to comparison shop for products. With traditional brick-and-mortar stores, a consumer must visit or call several different stores to obtain availability and pricing information for a particular product or service. Moreover, the consumer must visit the stores in a relatively small time span, as the availability and price of a product or service may change very quickly. With online stores and marketplaces, a customer can utilize a web browser, or similar application, to navigate relevant web pages of several different online stores to observe the availability and pricing information for a product or service of interest.

However, online shopping has several drawbacks. For example, when a product is purchased from an online store, the product must be shipped to the consumer from a warehouse or other location, resulting in a delay. Moreover, if a user wants to obtain specific product information (e.g., the cheapest price of the product and the quickest shipping time), the user must manually visit each website and compare such parameters by himself or herself.

Thus, what is needed is a customer-friendly and easy-to-use online service that makes it simple for customers to comparison shop by consolidating product information from multiple websites in real-time. Moreover, what is needed is an online e-commerce aggregation service or platform that allows customers to easily compare parameters associated with a given product offered by multiple websites.

### Review of Related Technology:

U.S. Published Patent Application No. 2017/0053295 A1 describes techniques for receiving data generated by multiple platforms of different types and providing the data and/or performing an analysis on the data. Such analysis may include aggregating the data, in examples. The results of the analysis may be provided to the data consumer(s) through a marketplace associated with a super-platform.

U.S. Pat. No. 10,402,884 B2 describes a web-based comparison shopping and marketplace service that enables a user to search for and/or browse products of interest, and then obtain geographically-relevant, real-time product availability and pricing information for the product of interest that is offered by one or more physical retail stores.

U.S. Pat. No. 9,836,774 B2 relates to a computer-implemented architecture that can provide a non-invasive comparative shopping tool, such as a browser plug-in. For example, the plug-in can determine whether a web user is currently visiting a purchase page, thus indicating that the web user is likely to be interested in purchasing items online. Upon making this determination, the plug-in can display a non-invasive listing (that can be quickly and conveniently dismissed) of comparable items at favorable prices (or with favorable features, etc.) that are available for purchase at other web sites. In addition, the plug-in can communicate with a data store, e.g., by way of the web, in order to help make various determination as well as to receive the listing of comparable items.

U.S. Pat. No. 9,817,539 B1 describes technologies for facilitating discovery of items added to electronic wish lists. Real-time messages that identify items that have been recently added to wish lists are received from a wish list service. A stream of real-time data is generated from the messages that identifies the items added to the wish lists. A network application programming interface (API) is exposed for providing the stream to clients. A client may obtain the stream from the network API and utilize the stream to generate a visualization of the items added to the wish lists in real-time. Through functionality provided by the API, the stream may also be filtered and searched.

U.S. Pat. No. 9,262,784 B2 describes computer implemented systems and methods for comparison shopping. One example embodiment includes receiving a data resource associated with a web page (where the web page includes an offering of a product and product offering terms), extracting product descriptors from the data source, requesting a search of marketplace offerings of the product based on the product descriptors, receiving results of the search (the results including marketplace offering terms of the marketplace offerings of the product), and displaying the marketplace offering terms, thereby facilitating comparison of the product offering terms with the marketplace offering terms.

WO 2014/145721 A2 and U.S. Published Patent Application No. 2014/0279656 A1 describe a system for providing individuals with comprehensive shipping and online purchasing information. The system receives online purchasing and shipping information associated with purchases, regardless of where an individual made the purchase (e.g., from any website), what items were purchased, and what carrier shipped the purchased items. The purchasing and shipping information is made available to the individual through an account and associated login. This allows individuals to conveniently view all shipping information and a detailed record of all online purchases in one location.

CA2404814C describes an apparatus, system, and method for online, multi-parcel, multi-carrier, and multi-service parcel returns shipping management.

WO 2005/069871 A2 describes techniques relating to the aggregation and use of local retail information for the purpose of providing a wide variety of valuable services to consumers and retailers.

WO 2008/060914 A2 describes a system (10), apparatus (12) and method (40) for providing content channels to end users based on end user wish lists. The method includes a domain channel manager apparatus accessing a plurality of end user wish lists maintained at end user devices, such as end user residential gateways and home servers. The domain channel manager accesses the plurality of wish lists and aggregates the wish list items, organizing and ranking the wish list items if necessary. Based on the aggregated wish list items from the plurality of end users, the domain channel manager retrieves content from all available content sources, such as content providers and existing content repositories. The domain channel manager creates content channels based on the retrieved content and offers those content channels to end users whose preferences match the content of the particular channel offered.

Various systems and methods are known in the art. However, their means of operation are substantially different from the present disclosure, as the other inventions fail to solve all the problems taught by the present disclosure.

### SUMMARY OF THE EMBODIMENTS

The present invention and its embodiments relates to an e-commerce aggregation platform. In particular, the field of the invention and its embodiments relate to a web-based comparison shopping and marketplace service that enables a user to search for and browse products and compare information associated with the products from different websites.

A first embodiment of the instant invention describes a system. The system includes a merchant server hosting a marketplace service. The system also includes a computing device. The marketplace service is configured to access a first website housing products and/or services and a second website housing products and/or services. The first website is associated with a first merchant and the second website is associated with a second merchant. The first merchant differs from the second merchant.

The marketplace service is further configured to perform an acquisition operation to extract information about a first product or a first service from the first website and from the second website and aggregate the information from the first website and the second website about the first product or the first service into a comparison format. It should be appreciated that in some examples, the comparison format may be used to compare one or more products from the same website. For example, the comparison format may compare three products from a first merchant (e.g., Amazon), two products from a second merchant (e.g., Wayfair), and one product from a third merchant (e.g., Lowes). In some example, the marketplace service is further configured to store the information about the first product or the first service from the first website and from the second website in a cache. It should be appreciated that the quantity of the websites is not limited to two.

The information includes a name of the first product or the first service, a category of the first product or the first service, a price of the first product or the first service, a unique identifier of the first product or the first service (e.g., an alphanumeric, numeric, or alphabetical identification of the first product or the first service), a return policy associated with the first product or the first service, a color of the first product or the first service, customer reviews associated with the first product or the first service, sizing of the first product or the first service, a shipping cost associated with the first product or the first service, a shipping method associated with the first product or the first service, shipping details associated with the first product or the first service, a textual description of the first product or the first service, an image of the first product or the first service, a video of the first product or the first service, and/or one or more products similar to the first product or one or more services similar to the first service, among other information not explicitly listed herein.

In one example, the acquisition operation uses an automated bot. In another example, the acquisition operation uses one or more scripts. In a further example, the acquisition operation comprises communication of a request to another service to ascertain the information. The request includes an application programming interface (API). It should be appreciated that the acquisition operation may comprise any method or means known to one having ordinary skill in the art.

The computing device includes a memory, a processor coupled to the memory, a graphical user interface (GUI), and a marketplace application. The marketplace application enables access to the marketplace service. The marketplace application is configured to receive a request from the user for the information associated with the first product or the first service. Then, the marketplace service is configured to: receive the request from the marketplace application, execute the request from the marketplace application, and display the comparison format of the information for the first product or the first service to the user via the GUI.

In some examples, the marketplace application is further configured to: receive a filter request from the user to filter one or more parameters of the comparison format. In examples, the filter request may include the user selecting key attributes from a broad list. In other examples, the filter request may include filtering pre-selected attributes. In other examples, the marketplace application is further configured to: receive a purchase transaction from the user for the first product or the first service. In another example involving the first product, the marketplace application is further configured to: receive a reservation request from the user for the first product for a subsequent pick-up at a physical store.

It should be appreciated that in the case of the first product, the marketplace service further comprises a calendar module that is configured to: manage parameters, such as: a return of the first product, a shipping of the first product, a method of delivery of the first product, a birthday of the user and/or another user, holidays, and/or a date of purchase of the first product, among others. Use of the calendar module provides an awareness of holidays to the user and additionally drives revenue to the retailers.

In additional examples, the marketplace service is further configured to: receive a first wish list of products from the user, receive a second wish list of products from another user, aggregate the first wish list and the second wish list into an aggregated format, and display the aggregated format. The marketplace service may also receive a filter request from the user to filter one or more parameters of the aggregated format. In additional examples, the marketplace service may be configured to receive a request to add, modify, and/or delete one or more parameters of the aggregated format. Further, users can purchase products directly from this aggregated format.

In further embodiments, the marketplace service is further configured to store information regarding shopping habits of the user from in a cache and transmit the information regarding the shopping habits of the user to another computing device. Such may be utilized to generate additional revenue.

A second embodiment of the present invention describes a system. The system includes a merchant server hosting a marketplace service and a computing device. The computing device includes a memory, a processor coupled to the memory, a graphical user interface (GUI), and a browser extension. The browser extension enables user access to the marketplace service. The browser extension is configured to receive: an addition, from a user, of a first website link associated with a first product and an addition of a second website link associated with a second product. The first product differs from the second product.

The marketplace service is further configured to: perform an acquisition or scraping operation to extract a first set of information about the first product from the first website and a second set of information about the second product from the second website, aggregate the first set of information and the second set of information, and display the first set of information and the second set of information.

In response to receiving, from the user, an addition of text or images associated with the first product or the second product, the marketplace service is further configured to update the display of the first set of information and the second set of information. Further, the marketplace service is configured to update the first set of information and the second set of information in real-time. Additionally, in some examples, the first set of information and the second set of information includes a current stock status of the first product and the second product.

### BRIEF DESCRIPTION OF THE DRAWINGS

FIG. 1 depicts a block diagram of a computer system, according to at least some embodiments described herein.

FIG. 2 depicts a block diagram of a marketplace service capable of accessing multiple websites, according to at least some embodiments described herein.

FIG. 3 depicts a block diagram of a comparison format comprising aggregated information of a product or a service from multiple websites, according to at least some embodiments described herein.

FIG. 4 depicts a block diagram of customer reviews for a product or a service, according to at least some embodiments described herein.

FIG. 5 depicts a schematic diagram of a calendar module of a marketplace service, according to at least some embodiments described herein.

FIG. 6 depicts a block diagram of a marketplace service capable of receiving multiple wish lists of products and/or services from users, according to at least some embodiments described herein.

FIG. 7 depicts a block diagram of a browser extension, according to at least some embodiments described herein.

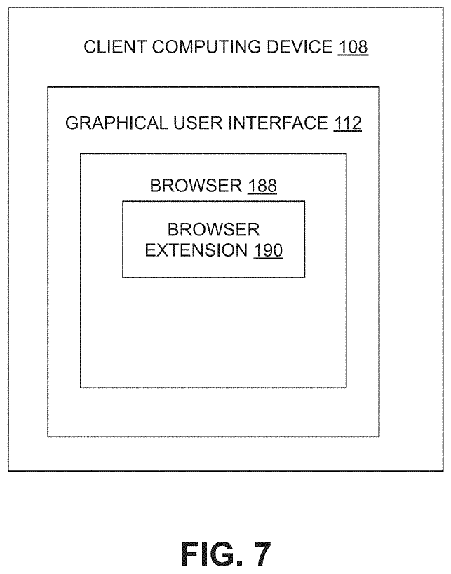

FIG. 8 is a block diagram of a computing device included within the computer system of FIG. 1, in accordance with embodiments of the present invention.

FIG. 9 depicts a schematic diagram of a home screen of a user profile in a marketplace service, according to at least some embodiments described herein.

FIG. 10 depicts a schematic diagram of a marketplace service through which a user can add a shopping list, according to at least some embodiments described herein.

FIG. 11 depicts a schematic diagram of a blank shopping list in a marketplace service, according to at least some embodiments described herein.

FIG. 12 depicts a schematic diagram of a shopping list in a marketplace service, according to at least some embodiments described herein.

FIG. 13 depicts a schematic diagram of additional information regarding a product in a shopping list of a marketplace service, according to at least some embodiments described herein.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

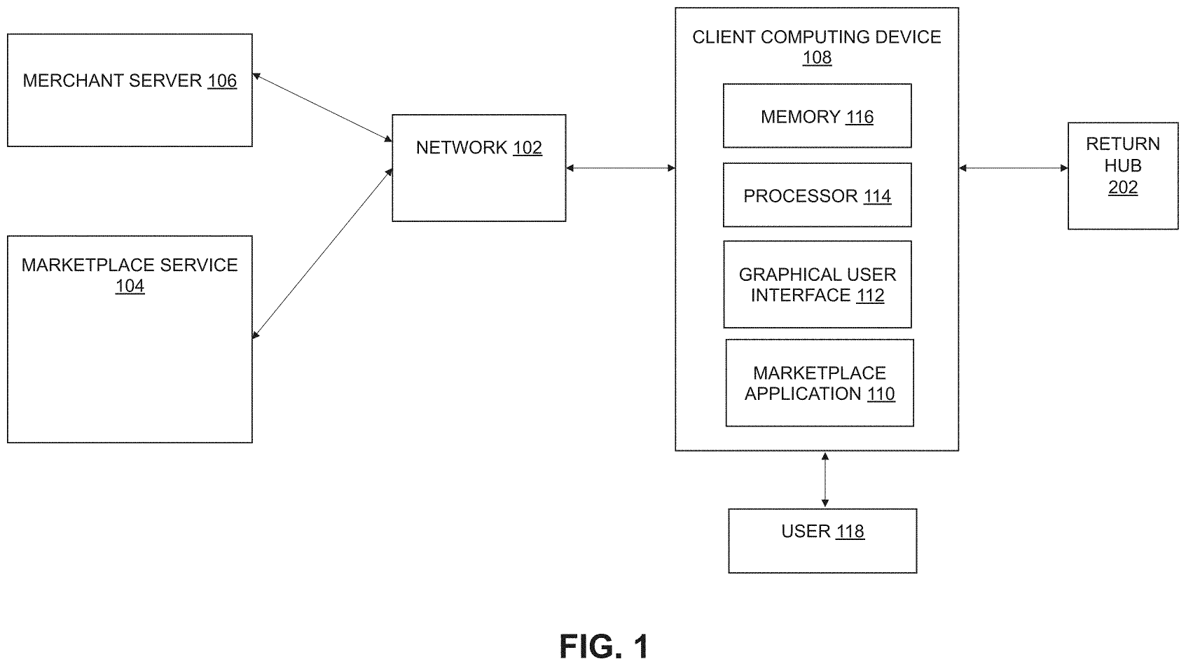

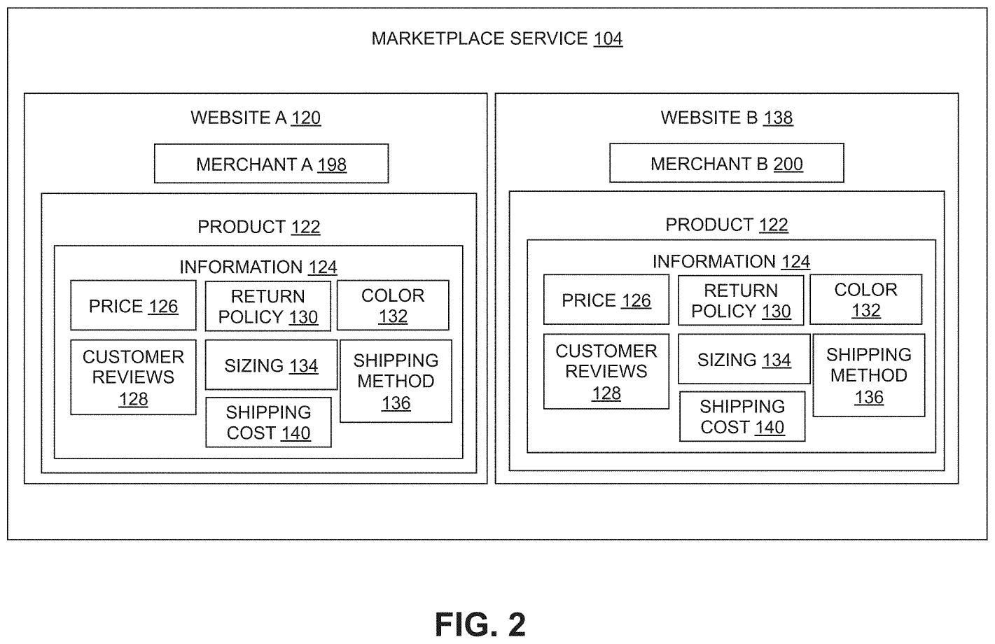

A system is described and depicted at least in FIG. 1 herein. The system includes a merchant server 106 hosting a marketplace service 104 and a computing device 108 (e.g., a client computing device). The marketplace service 104 functions as an e-commerce aggregation platform that allows a user 118 to compare products or services offered for sale on multiple websites. The marketplace service 104 is configured to access a first website (e.g., a website A 120) offering products and/or services for sale and a second website (e.g., a website B 138) offering products and/or services for sale, as shown in FIG. 2. The first website (e.g., the website A 120) is associated with a first merchant (e.g., a merchant A 198) and the second website (e.g., the website B 138) is associated with a second merchant (e.g., a merchant B 200). The first merchant (e.g., the merchant A 198) differs from the second merchant (e.g., the merchant B 200). Examples of merchant websites may include: Amazon, Target, Walmart, Best Buy, Etsy, Wayfair, Williams-Sonoma, Inc., Macys, or Bloomingdales, etc.

In an illustrative example, the marketplace service 104 is further configured perform an acquisition operation to extract information 124 (of FIG. 2) about a first product 122 from the first website (e.g., the website A 120) and from the second website (e.g., the website B 138). It should be appreciated that the quantity of websites is not limited to two. In one example, the acquisition operation uses an automated bot. In another example, the acquisition operation uses one or more scripts. In other examples, the acquisition operation uses one or more links and/or plugins. In a further example, the acquisition operation comprises communicating a request to another service to ascertain the information 124. In this example, the request may include an application programming interface (APT). As described herein, the APT is a computing interface that defines interactions between multiple software intermediaries and defines the kinds of calls or requests that can be made, how to make them, the data formats that should be used, the conventions to follow, etc. It should be appreciated that the acquisition operations are described for illustrative purposes only and other operations are contemplated by Applicant.

For example, in some implementations, web scraper technology may be used. As described herein, “web scraping” or “web data extraction” is data scraping used for extracting data from websites. The web scraping software may directly access the World Wide Web using the Hypertext Transfer Protocol or a web browser.

Furthermore, the present invention describes systems and methods to control the web scraping through a plurality of web servers using real-time access statistics such that the real-time statistics of access patterns are used to identify excessive traffic and to minimize the impact of web scrapers on the system.

It should be appreciated that the information 124 includes a name of the first product 122, a category of the first product 122, a price 126 of the first product 122, a unique identifier of the first product 122, a return policy 130 associated with the first product 122, a color or colors 132 of the first product 122, customer reviews 128 associated with the first product 122, sizing 134 of the first product 122, a shipping cost 140 associated with the first product 122, a shipping method 136 associated with the first product 122, weight of the first product 122, shipping details associated with the first product 122, a textual description of the first product 122, an image of the first product 122, a video of the first product 122, and/or one or more products similar to the first product 122, among other information not explicitly listed herein.

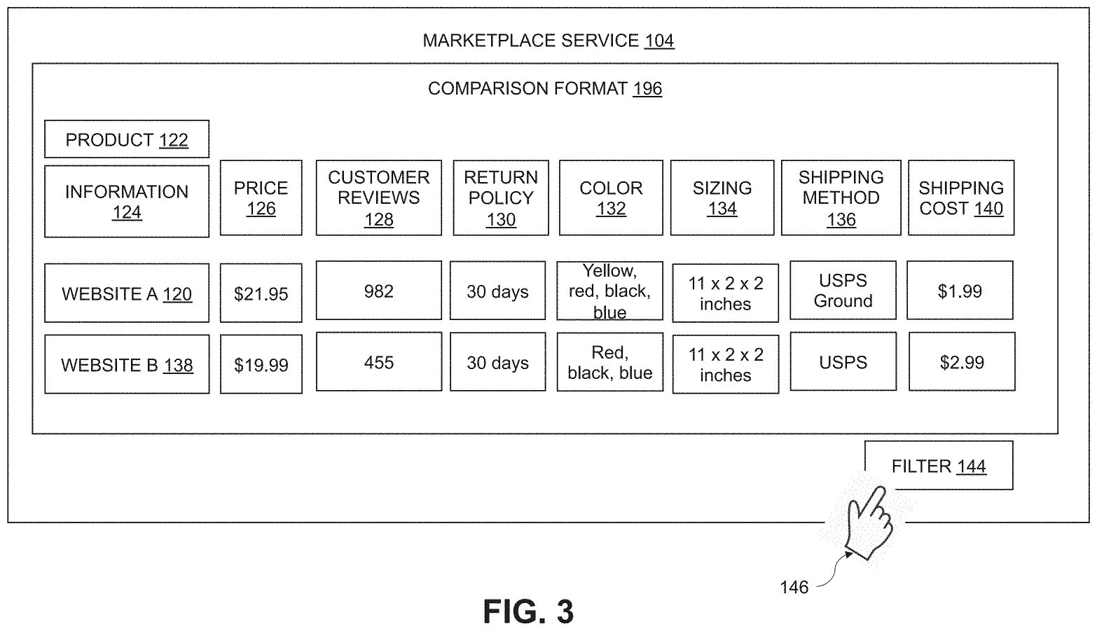

Next, the marketplace service 104 is configured to aggregate the information 124 about the first product 122 into a comparison format 196, as depicted in FIG. 3. The comparison format 196 may include a table, a chart, a graph, a grid-type display, a pictorial display, etc. It should be appreciated that the comparison format 196 is not limited to any of the illustrative examples described herein and other examples are contemplated.

The marketplace service 104 is further configured to store the information 124 about the first product 122 from the first website (e.g., the website A 120) and from the second website (e.g., the website B 138) in a cache. In other examples, more than one level of caching may be used for this purpose. In additional examples, the information 124 may be cached locally at the marketplace service 104 so that a response to a subsequent search for the same product can be serviced with the information stored in the cache. It should be appreciated that the marketplace service 104 is configured to store the information 124 and the comparison format 196 in any fashion.

Further, as depicted in FIG. 1, the computing device 108 includes a memory 116, a processor 114 coupled to the memory 116, a graphical user interface (GUI) 112, and a marketplace application 110. It should be appreciated that the computing device 108 may be a computer, a laptop computer, a smartphone, and/or a tablet, among other examples not explicitly listed herein. In examples, the marketplace application 110 may be an engine, a software program, a service, or a software platform configured to be executable on the computing device 108. The user 118 is configured to interact with the marketplace application 110 via the GUI 112. Moreover, the marketplace application 110 allows the user 118 to access the marketplace service 104 via a network 102.

The marketplace application 110 is configured to first receive, from the user 118, login credentials to a profile associated with the user 118. The login credentials may include a username, a password, a biometric identification means (e.g., fingerprint identification, face recognition identification, palm print identification, iris recognition, retina recognition, etc.), etc. In response, the marketplace service 104 may identify the user 118 based on the login credentials. Identification of the user 118 may include information, such as: a name of the user 118, a telephone number of the user 118, an address of the user 118, a birthdate of the user 118, types of products and/or services purchased by the user 118, etc. In response to a determination that the user 118 has a profile, the user 118 is authorized to access and interact with the marketplace application 110. In response to a determination that the user 118 does not have a profile, the user 118 is required to create such profile prior to accessing and interacting with the marketplace application 110.

The marketplace application 110 is then configured to receive a request from the user 118 for the information 124 associated with the first product 122. The request may include a search query for the first product 122, which may include: free-form text input into a search text input box, or by the user 118 selecting various graphical user interface elements, for example, to specify certain attributes of a desired product. Then, the marketplace service 104 is configured to: receive the request from the marketplace application 110, execute the request from the marketplace application 110, and display the comparison format 106 of the information 124 for the first product 122 to the user via the GUI 112. Such execution and display occurs in real-time.

As an illustrative example of this process thus far, the marketplace service 104 is configured to utilize the automated bot to extract the information 124 about an umbrella (e.g., the first product 122) from multiple websites, such as the website A 120 (e.g., Amazon) and the website B 138 (e.g., Macys). The information 124 associated with the umbrella from the website A 120 (e.g., Amazon) may include: the name of the umbrella (e.g., “Stay Dry”), an identification associated with the umbrella (e.g., an identification number 09293), the price of the umbrella (e.g., $21.95), the return policy associated with the umbrella (e.g., returns accepted within 30 days of purchase accompanied with the original receipt), the colors associated with the umbrella (e.g., yellow, red, black, or blue), customer reviews associated with the umbrella (e.g., 982 reviews), sizing of the umbrella (e.g., 11×2×2 inches), the shipping cost associated with the umbrella (e.g., $1.99), the shipping method associated with the umbrella (e.g., USPS), the shipping details associated with the umbrella (e.g., usually ships 1-2 days after purchase), the textual description of the umbrella (e.g., “The umbrella is durable and comprises a nine-rib construction that holds up against gale-force winds.”), the image of the umbrella, the video demonstrating use of the umbrella, and other umbrellas similar in shape, size, price and configuration to the umbrella.

The information 124 associated with the umbrella from the website B 138 (e.g., Macys) may include the name of the umbrella (e.g., “Stay Dry”), an identification associated with the umbrella (e.g., an identification number 09293), the price of the umbrella (e.g., $19.99), the return policy associated with the umbrella (e.g., returns accepted within 30 days of purchase with the original receipt), the colors associated with the umbrella (e.g., red, black, or blue), customer reviews associated with the umbrella (e.g., 455 reviews), sizing of the umbrella (e.g., 11×2×2 inches), the shipping cost associated with the umbrella (e.g., $2.99), the shipping method associated with the umbrella (e.g., USPS), the shipping details associated with the umbrella (e.g., usually ships 1-2 days after purchase), the textual description of the umbrella (e.g., “The umbrella is durable and comprises a nine-rib construction that holds up against gale-force winds.”), the image of the umbrella, the video demonstrating use of the umbrella, and other umbrellas similar in shape, size, price and configuration to the umbrella.

Next, the marketplace service 104 is configured to aggregate the information 124 about the first product 122 (e.g., the umbrella) into the comparison format 196, as depicted in FIG. 3, and may further store the information 124 in any method. The user may interact with the marketplace application 110 via the GUI 112 to access the marketplace service 104. In some examples, the marketplace application 110 is further configured to: receive a request 146 to filter 144 from the user 118 to filter one or more parameters of the comparison format 196, as shown in FIG. 3. For example, the user 118 may wish to only view and compare the name of the umbrella, the sizing of the umbrella, the price of the umbrella, the shipping cost of the umbrella, and the return policy associated with the umbrella. However, it should be appreciated that the user 118 may filter and view any of the information 124 described herein.

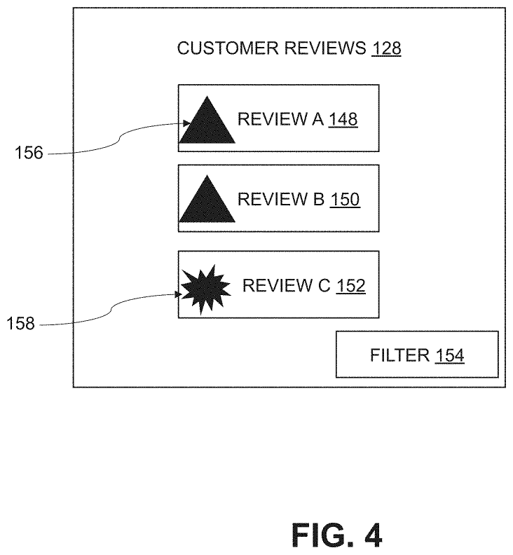

In another example, and as depicted in FIG. 4, the customer reviews 128 may be filtered 154 by the user 118. The customer reviews 128 may include a first review (e.g., a review A 148) from a first reviewer, a second review (e.g., a review B 150) from a second reviewer, and a third review (e.g., a review C 152) from a third reviewer. It should be appreciated that the quantity of the reviews and/or the reviewers is not limited to any particular quantity. Each of the reviews 128 may comprise graphics, text and/or videos. In some examples, the customer rating of the product or service may comprise a numerical rating (e.g., a rating of 5), a fraction rating (e.g., a 6/10 rating), a graphic rating (e.g., three stars out of five stars), etc. The means of displaying the customer rating of the product or service is non-limiting.

Such filtering may occur based on: a date of the review, a type of reviewer (e.g., a verified reviewer as compared to an unverified reviewer), etc. As shown in FIG. 4, reviews (e.g., the review A 148 and the review B 150) associated with a reviewer verified by the marketplace service 104 may comprise a first graphical image 156 next to the review. A review (e.g., the review C 152) associated with a reviewer unverified by the marketplace service 104 may comprise a second graphical image 158 next to the review, where the first graphical image 156 differs from the second graphical image 158.

Moreover, the marketplace service 104 may apply a means or mechanism to identify and flag any text, photographs, and/or videos that comprise profanity and/or undesirable commentary. Such flagged content may be transmitted to an administrator of the marketplace service 104 for further review prior to posting/submission.

In other examples, the marketplace application 110 is further configured to: receive a purchase transaction from the user 118 for the first product 122. In another example, the marketplace application 110 is configured to receive a product reservation request from the user 118 for the first product 122 for a subsequent pick-up at a physical store.

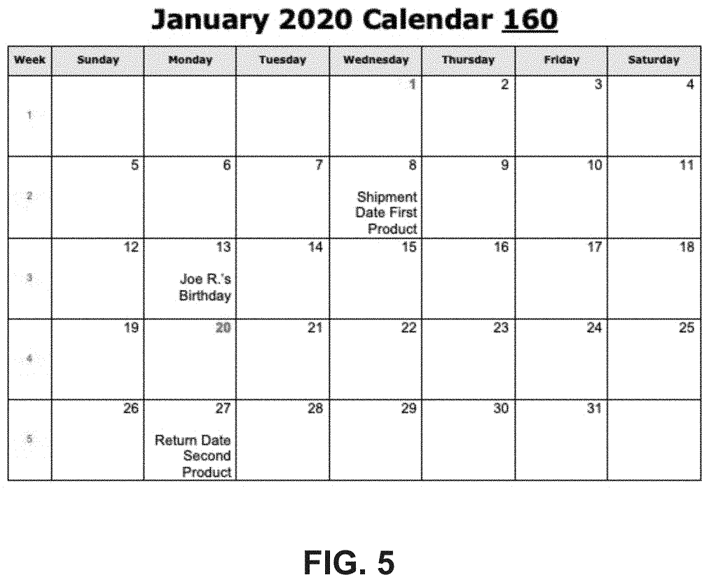

It should be appreciated that the marketplace service 104 further comprises a calendar module 160 of FIG. 5. The user 118 may interact with this calendar module 160 to add, modify, or delete parameters, such as: a return of the first product 122, a shipping of the first product 122, a method of delivery of the first product 122, loyalty points associated with a website, a birthday of the user and/or another user, holidays, and/or a date of purchase of the first product 122, among others. It should be appreciated that the calendar module 160 may be implemented as software, hardware, or a combination of software and hardware. For instance, this module may be implemented as a set of software instructions for execution on one or more processors (e.g., such as a general purpose computer processor or an application-specific circuit). This module may reside on a single server or multiple servers and may be combined in various combinations.

It should further be appreciated that in some examples, the user 118 may link his/her own personal calendar(s) with the calendar module 160 such that the user 118 may add, modify, or delete events from the calendar module 160. The marketplace service 104 may also engage one or more social media websites or services such that the user 118 may add, modify, or delete events associated with one or more social media contacts or connections. For example, the user 118 may be connected to a friend, Jim Smith, on the social media platform of Facebook. Jim Smith invited the user 118 to attend a BBQ on July 3^{rd}. The user 118 may add this BBQ event to the calendar associated with the calendar module 160.

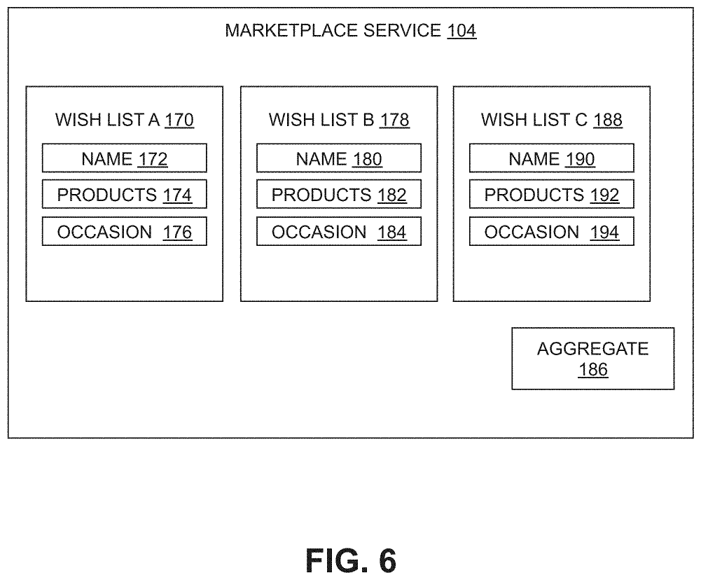

The marketplace service 104 may also receive and manage wish lists, as shown in FIG. 6. As described herein, a “wish list” is a collection of desired products and/or services compiled by users, signifying interest without an immediate intent to purchase such products and/or services. In additional examples, the marketplace service 104 is further configured to: receive a first wish list (e.g., a wish list A 170) of a first set of products 174 from the user (e.g., the name 172), receive a second wish list (e.g., a wish list B 178) of a second list of products 182 from another user (e.g., the name 180), and a third wish list (e.g., a wish list C 188) of a third list of products 192 from an additional user (e.g., the name 190). In some examples, each of these wish lists may be associated with an occasion (e.g., an occasion 176, an occasion 184, and/or an occasion 194). Such occasions may include a birthday, a bridal shower, a wedding, a retirement party, etc.

In some examples, a third-party user may add to one or more of these wish lists. The marketplace service 104 may then aggregate 186 the first wish list (e.g., the wish list A 170), the second wish list (e.g., the wish list B 178) and the third wish list (e.g., the wish list C 188) into an aggregated format. The marketplace service 104 may also display this aggregated format. The marketplace service 104 may also receive a filter request from the user 118 to filter one or more parameters of the aggregated format. In additional examples, the marketplace service 104 may be configured to receive a request to add, modify, and/or delete one or more parameters of the aggregated format.

In further embodiments, the marketplace service 104 is further configured to store information regarding shopping habits of the user 118 from in a cache and transmit the information regarding the shopping habits of the user 118 to another computing device. Such may provide an additional stream of revenue. Moreover, other data may be analyzed and compiled that includes an identification of a product, a date the product was sold, a quantity of the product that was sold, etc. As an illustrative example, the data may include a sales quantity of a specific hand drill at Lowes around the December holiday season in 2020. Such data may be compiled into a consumer report (or another sort of report or chart) and may be used by retailers to determine factors surrounding products sold by that given retailer. For example, Lowes may compare these sale statics with those of Home Depot to determine how Lowes can modify their marketing or advertising campaigns to drive sales during future December holiday seasons. This provides another stream of revenue.

In another example, the computing device 108 may include a browser extension 190 on a bowser 188 that enables the user 118 to access the marketplace service 104. The browser extension 190 is configured to receive an addition from the user 118 of a first website link associated with the first product or service and receive an addition from the user 118 of a second website link associated with the first product or service. Next, the marketplace service is configured to: perform an acquisition operation to extract information about the first product or service from the first website and from the second website, aggregate the information about the first product or service into a comparison format, and display the comparison format to the user 118.

In another illustrative example, a brick and mortar and physical location return hub 202 may be present in the system, as shown in FIG. 1. The return hub 202 may be configured as a standalone location (such as a kiosk), may be part of a retailer, or may be part of a shipping company (e.g., FedEx). If the user 118 purchases a physical item using the marketplace application 110, the user 118 may drop off the physical item at the return hub 202 for the return hub 202 to facilitate the return of the physical item to the retailer. In some examples, the calendar module 160 may be automatically updated for the user 118 based on the return of the physical item.

In an illustrative example, the user 118 may drop off the physical item at the return hub 202 without any sort of return packaging. Then, the return hub 2020 facilitates the return of the physical item. In some examples, the return hub 202 may utilize a transportation service to transport the physical item for return back to the retailer. Such transportation service is not limited to any particular service or means.

In some examples, the user 118 may only be provided access to the services offered by the return hub 202 if the user 118 has paid a subscription for the marketplace service 104 or has paid a fee for this service. In other examples, the user 118 may only be provided access to the services offered by the return hub 202 if the user 118 has clicked through the comparison format 196. In additional examples, the marketplace service 104 may receive a commission from the retailer for providing such service.

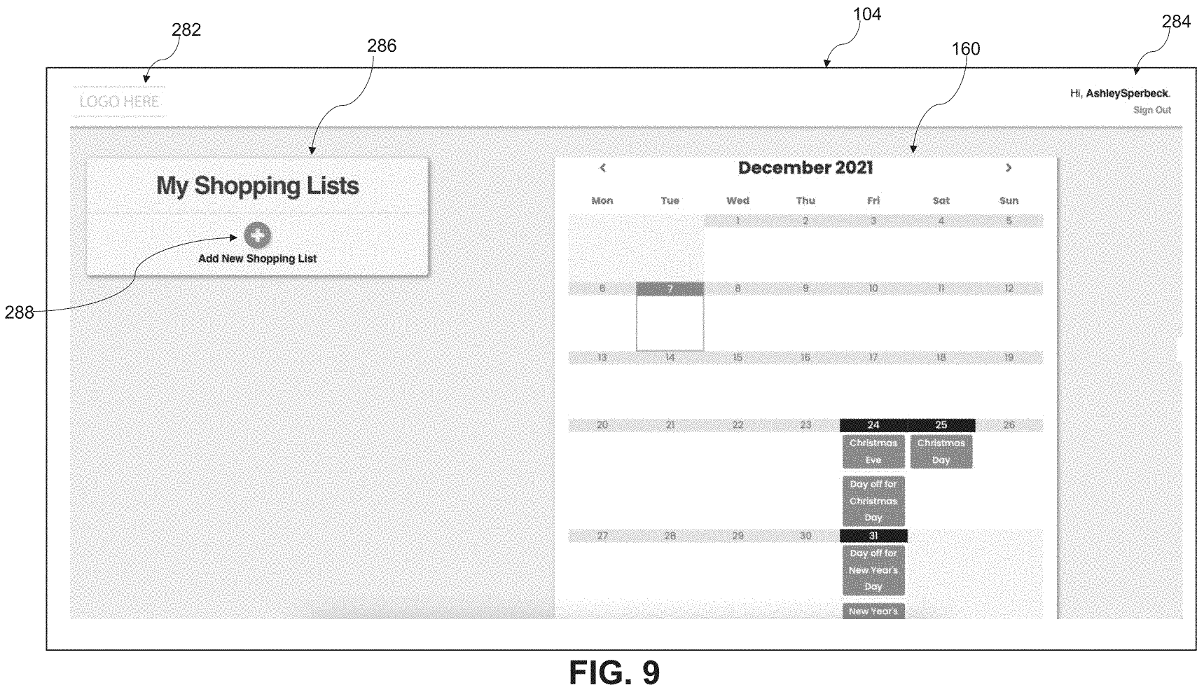

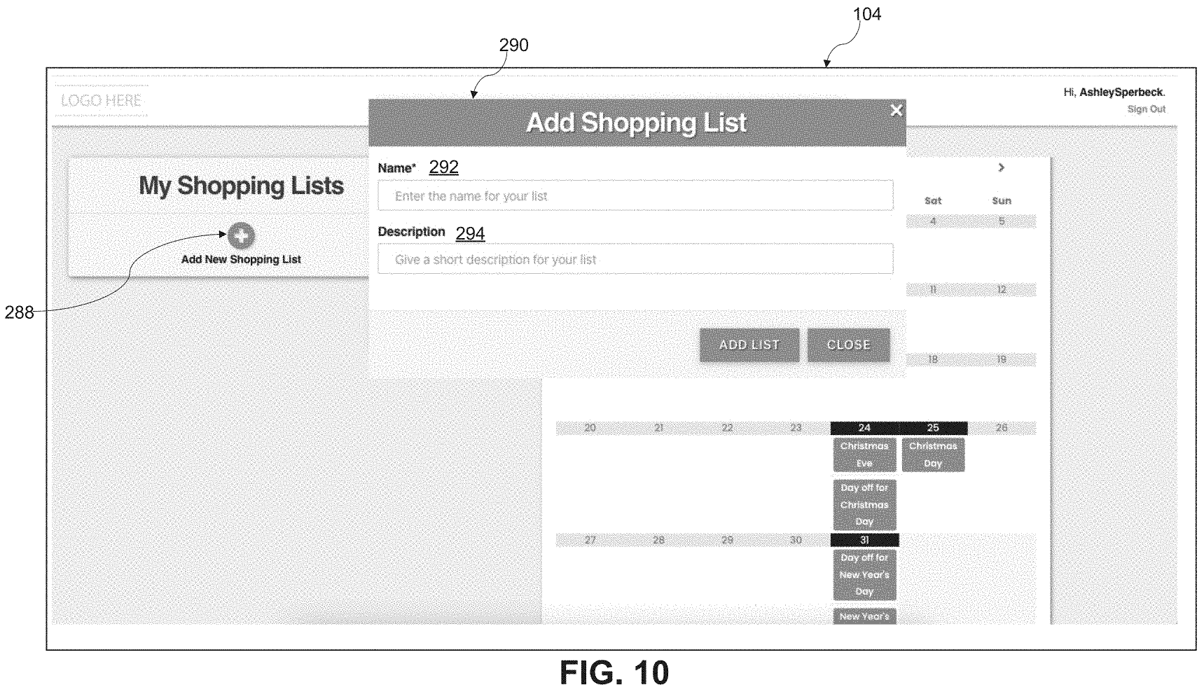

Moreover, FIG. 9-FIG. 13 depict schematic diagrams of the marketplace service 104. Specifically, FIG. 9 depicts a schematic diagram of a home screen of a user profile in the marketplace service 104 and FIG. 10-FIG. 13 depict schematic diagrams of the marketplace service 104 through which the user 118 can add and manage a shopping list.

As explained supra, the user 118 may input login credentials to access the user profile of the marketplace service 104. As shown in FIG. 9, the user profile may include: a name 284 of the user 118 and/or an image, logo, avatar, etc. 282 associated with the user 118. In some implementations, the user profile may alternatively or additionally include: a home address associated with the user 118, a telephone number associated with the user 118, and/or a saved payment option associated with the user 118, among other factors not explicitly listed herein. Further, the user 118 may add, modify or delete one or more of these features based on the preferences of the user 118.

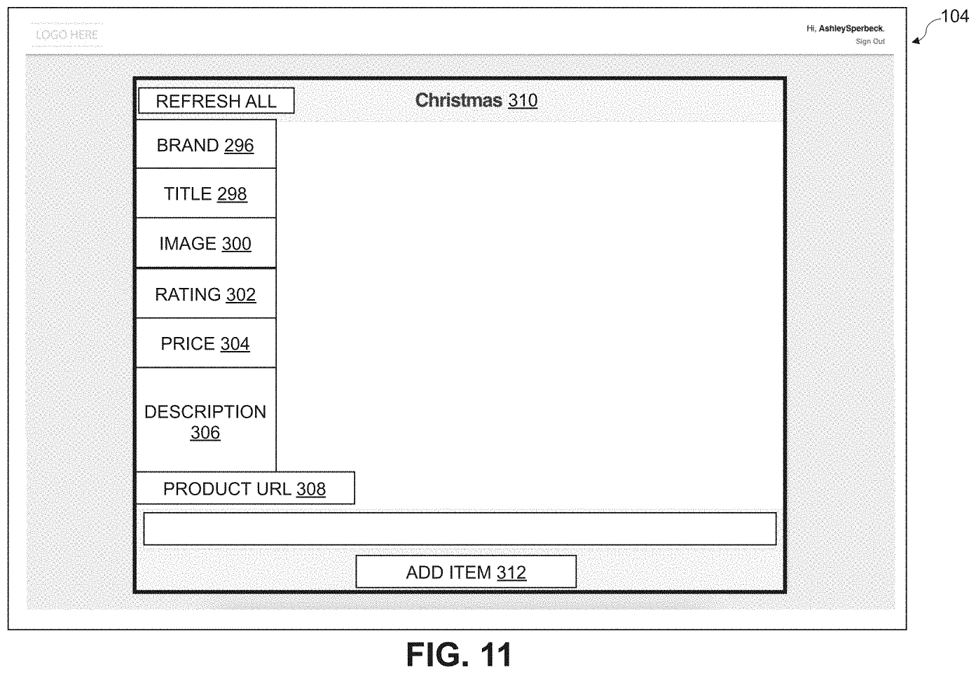

Further, as shown in FIG. 9, the home screen of the user profile may include the calendar module 160, as well as a “My Shopping List” module 286. The user 118 may engage the “My Shopping List” module 286 at an “Add New Shopping List” button 288 to add one or more shopping lists to the “My Shopping List” module 286. If the user 118 engages the button 288, an “Add Shopping List” window 290 (of FIG. 10) may appear. The window 290 allows the user 118 to input text for: (1) a name 292 of the new shopping list, (2) a description 294 of the new shopping list, and/or one or more images or graphics associated with the new shopping list. Once the user 118 completes these actions, the new shopping list is created (e.g., a Christmas shopping list 310 of FIG. 11).

As shown in FIG. 11, the user 118 inputs a product URL 308 associated with an external website (e.g., Amazon) into an “Add Item” button 312. By doing so, a product or item associated with the product URL 308 is added to the new shopping list (e.g., the Christmas shopping list 310). As shown in FIG. 11, once the product or item has been added to the new shopping list (e.g., the Christmas shopping list 310), various information associated with the product or item is displayed, such as: a name of a brand 296 associated with a product or item, a title 298 of a given product or item, an image 300 of the product or item, an average rating 302 associated with the product or item, a current price 304 of the product or item, and/or a description 306 of the product or item, among other information not explicitly listed herein. It should be appreciated that this information is taken directly from the external website. As shown in FIG. 11, the user 118 may also engage a “Refresh All” button to update this information in real-time. In some instances, doing so will update a status of a given product (e.g., “out of stock,” or “back ordered”).

It should be appreciated that the average rating 302 associated with the product or item may be viewed as a number (e.g., a rating of 5), a fraction (e.g., a 6/10 rating), a graphic (e.g., three stars out of five stars), etc. The means of displaying the average rating 302 is non-limiting.

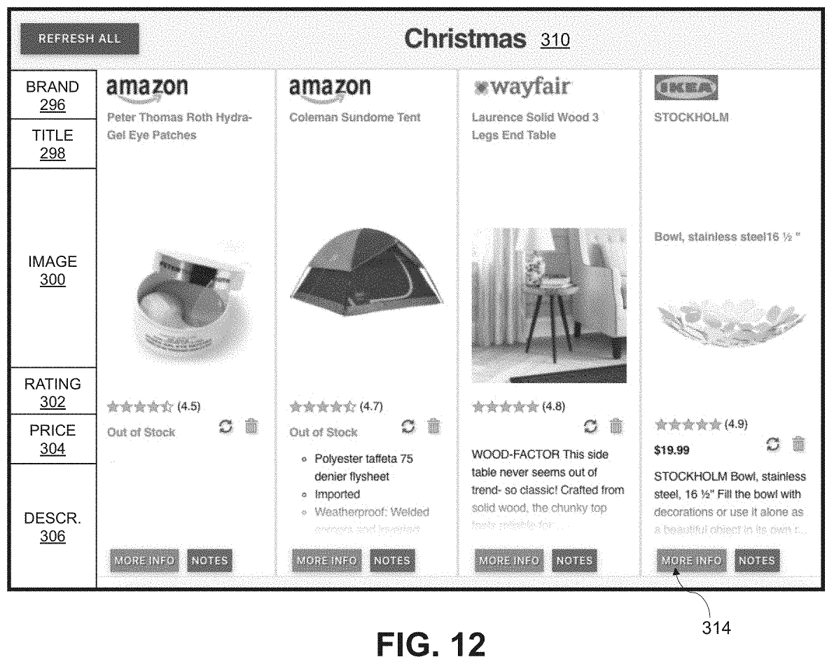

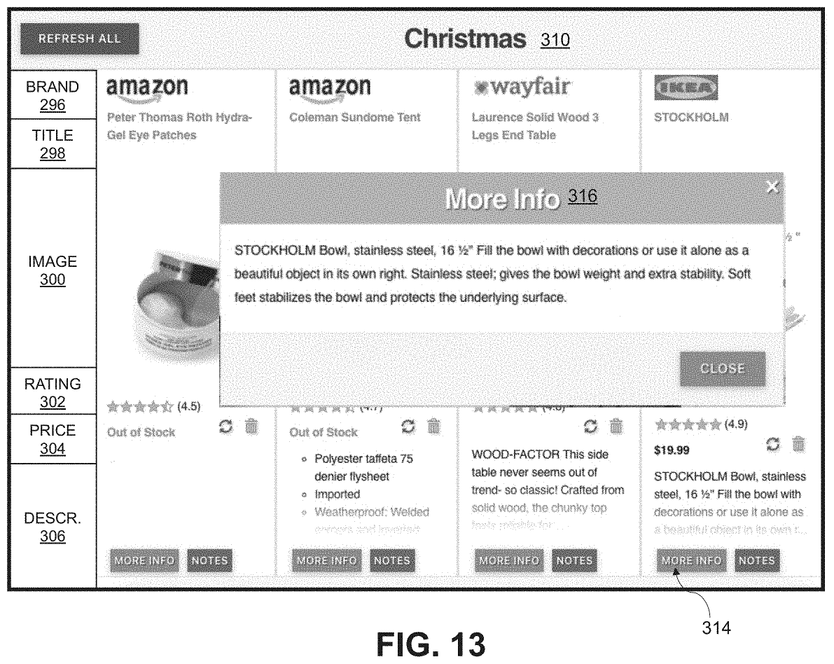

FIG. 12 depicts numerous products added to the new shopping list (e.g., the Christmas shopping list 310). If the user 118 would like to view more information regarding a specific product or item, the user 118 may engage a “More Information” button 314. In response, a new window will appear (e.g., a “More Information” window 316), as shown in FIG. 13. As shown in FIG. 13, the “More Information” window 316 includes additional textual information associated with the given product or item. Additionally, it should be appreciated that though select brands are depicted in FIG. 12 and FIG. 13, the marketplace service 104 is not limited to these particular brands.

In other embodiments, the user 118 may add notes including text and/or images to the products or items in the new shopping list (e.g., the Christmas shopping list 310) or to the new shopping list (e.g., the Christmas shopping list 310).

In further embodiments, the marketplace service 104 allows the user 118 to transfer the new shopping list (e.g., the Christmas shopping list 310) to one or more other parties via email, text, etc.

### Computing Device

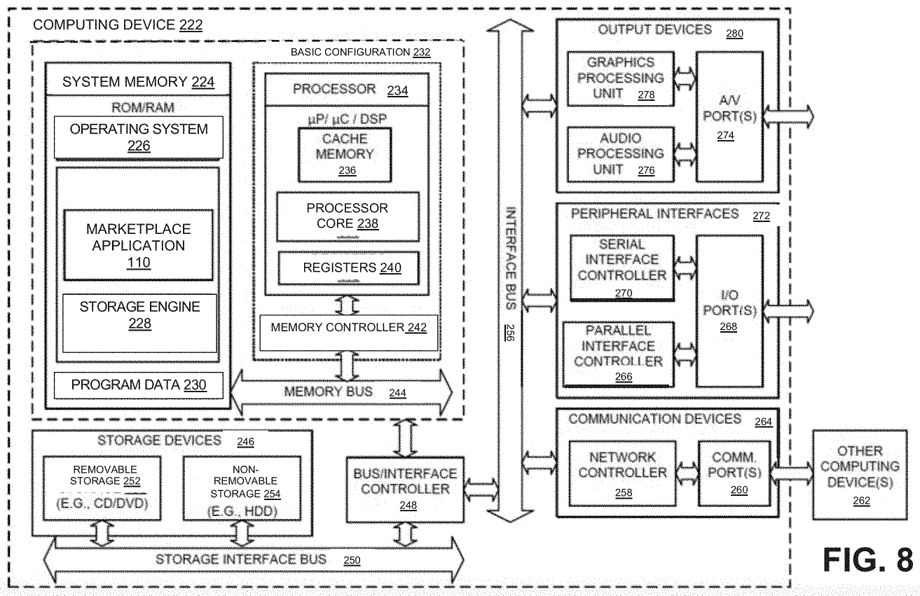

FIG. 8 is a block diagram of a computing device included within the computer system of FIG. 1, in accordance with embodiments of the present invention. In some embodiments, the present invention may be a computer system, a method, and/or the computing device 108 (of FIG. 1) or the computing device 222 (of FIG. 8).

A basic configuration 232 of a computing device 222 is illustrated in FIG. 8 by those components within the inner dashed line. In the basic configuration 232 of the computing device 222, the computing device 222 includes a processor 234 and a system memory 224. In some examples, the computing device 222 may include one or more processors and the system memory 224. A memory bus 244 is used for communicating between the one or more processors 234 and the system memory 224.

Depending on the desired configuration, the processor 234 may be of any type, including, but not limited to, a microprocessor (μP), a microcontroller (C), and a digital signal processor (DSP), or any combination thereof. Further, the processor 234 may include one more levels of caching, such as a level cache memory 236, a processor core 238, and registers 240, among other examples. The processor core 238 may include an arithmetic logic unit (ALU), a floating point unit (FPU), and/or a digital signal processing core (DSP Core), or any combination thereof. A memory controller 242 may be used with the processor 234, or, in some implementations, the memory controller 242 may be an internal part of the memory controller 242.

Depending on the desired configuration, the system memory 224 may be of any type, including, but not limited to, volatile memory (such as RAM), and/or non-volatile memory (such as ROM, flash memory, etc.), or any combination thereof. The system memory 224 includes an operating system 226, one or more engines, such as the marketplace application 110, and program data 230. In some embodiments, the marketplace application 110 may be an engine, a software program, a service, or a software platform, as described infra. The system memory 224 may also include a storage engine 228 that may store any information disclosed herein.

Moreover, the computing device 222 may have additional features or functionality, and additional interfaces to facilitate communications between the basic configuration 232 and any desired devices and interfaces. For example, a bus/interface controller 248 is used to facilitate communications between the basic configuration 232 and data storage devices 246 via a storage interface bus 250. The data storage devices 246 may be one or more removable storage devices 252, one or more non-removable storage devices 254, or a combination thereof. Examples of the one or more removable storage devices 252 and the one or more non-removable storage devices 254 include magnetic disk devices (such as flexible disk drives and hard-disk drives (HDD)), optical disk drives (such as compact disk (CD) drives or digital versatile disk (DVD) drives), solid state drives (SSD), and tape drives, among others.

In some embodiments, an interface bus 256 facilitates communication from various interface devices (e.g., one or more output devices 280, one or more peripheral interfaces 272, and one or more communication devices 264) to the basic configuration 232 via the bus/interface controller 256. Some of the one or more output devices 280 include a graphics processing unit 278 and an audio processing unit 276, which are configured to communicate to various external devices, such as a display or speakers, via one or more A/V ports 274.

The one or more peripheral interfaces 272 may include a serial interface controller 270 or a parallel interface controller 266, which are configured to communicate with external devices, such as input devices (e.g., a keyboard, a mouse, a pen, a voice input device, or a touch input device, etc.) or other peripheral devices (e.g., a printer or a scanner, etc.) via one or more I/O ports 268.

Further, the one or more communication devices 264 may include a network controller 258, which is arranged to facilitate communication with one or more other computing devices 262 over a network communication link via one or more communication ports 260. The one or more other computing devices 262 include servers, the database, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 224, the one or more removable storage devices 252, and the one or more non-removable storage devices 254 are examples of the computer-readable storage media. The computer-readable storage media is a tangible device that can retain and store instructions (e.g., program code) for use by an instruction execution device (e.g., the computing device 222). Any such, computer storage media is part of the computing device 222.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein regarding illustrations and/or block diagrams of methods, computer systems, and computing devices according to embodiments of the invention. It will be understood that each block in the block diagrams, and combinations of the blocks, can be implemented by the computer-readable instructions (e.g., the program code).

The computer-readable instructions are provided to the processor 234 of a general purpose computer, special purpose computer, or other programmable data processing apparatus (e.g., the computing device 222) to produce a machine, such that the instructions, which execute via the processor 234 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 222), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

Another embodiment of the invention provides a method that performs the process steps on a subscription, advertising, and/or fee basis. That is, a service provider can offer to assist in the method steps described herein. In this case, the service provider can create, maintain, and/or support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

In some examples, this marketplace service 104 may serve as a partner to retailers. In some examples, a free version of the marketplace service 104 may be available. In other examples, a subscription-based model of the marketplace service 104 may be available. In further embodiments, a commission structured model of the marketplace service 104 may be available. It should further be appreciated that the type of fee structure associated with the marketplace service 104 may be based on the type of user. For example, an individual consumer may be able to access the free version of the marketplace service 104, whereas a retailer may utilize the subscription-based model of the marketplace service 104.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A system comprising:
a merchant server hosting a marketplace service;
the marketplace service being configured to:
access a first website housing products and a second website housing products;
perform an acquisition operation to extract information about a first product of the products from the first website and from the second website; and
aggregate the information about the first product into a comparison format;
a computing device comprising:
a memory;
a processor coupled to the memory;
a graphical user interface (GUI); and
a marketplace application that enables access to the marketplace service, the marketplace application being configured to receive a request from the user for the information associated with the first product; and
the marketplace service being configured to:
receive the request from the marketplace application; and
in response to an execution of the request from the marketplace application, display the comparison format of the information for the first product to the user via the GUI.

2. The system of claim 1, wherein the acquisition operation comprises use of an automated bot.

3. The system of claim 1, wherein the acquisition operation comprises use of one or more scripts.

4. The system of claim 1, wherein the acquisition operation comprises a communication of a request to another service to ascertain the information, and wherein the request comprises an application programming interface (API).

5. The system of claim 1, wherein the marketplace service is further configured to store the information about the first product from the first website and from the second website in a cache.

6. The system of claim 1, wherein the information is selected from the group consisting of:
a name of the first product, a category of the first product, a price of the first product, a unique identifier of the first product, a return policy associated with the first product, a color of the first product, customer reviews associated with the first product, sizing of the first product, a shipping cost associated with the first product, a shipping method associated with the first product, shipping details associated with the first product, a textual description of the first product, an image of the first product, a video of the first product, one or more products similar to the first product, and a current stock status of the first product.

7. The system of claim 1, wherein the marketplace service is further configured to:
receive a filter request from the user to filter one or more parameters of the comparison format.

8. The system of claim 1, wherein the marketplace service is further configured to:
receive a purchase transaction from the user for the first product.

9. The system of claim 1, wherein the marketplace service is further configured to:
receive a product reservation request from the user for the first product for a subsequent pick-up at a physical store.

10. The system of claim 1, wherein the first website is associated with a first merchant, wherein the second website is associated with a second merchant, and wherein the first merchant differs from the second merchant.

11. The system of claim 1, wherein the marketplace service further comprises:
a calendar module configured to manage parameters selected from the group consisting of: a return of the first product, a shipping of the first product, a method of delivery of the first product, a birthday of the user and/or another user, holidays, and a date of purchase of the first product.

12. The system of claim 1, wherein the marketplace service is further configured to:
receive a first wish list of products from the user;
receive a second wish list of products from another user;
aggregate the first wish list and the second wish list into an aggregated format; and
display the aggregated format.

13. The system of claim 12, wherein the marketplace service is further configured to:
receive a filter request from the user to filter one or more parameters of the aggregated format.

14. The system of claim 12, wherein the marketplace service is further configured to:
receive a request to add, modify, and/or delete one or more parameters of the aggregated format.

15. The system of claim 1, wherein the marketplace service is further configured to store information regarding shopping habits of the user from in a cache.

16. The system of claim 15, wherein the marketplace service is further configured to transmit the information regarding the shopping habits of the user to another computing device.

17. A system comprising:
a merchant server hosting a marketplace service; and
a computing device comprising:
a memory;
a processor coupled to the memory;
a graphical user interface (GUI); and
a browser extension that enables access to the marketplace service, the browser extension being configured to:
receive an addition from a user of a first website link associated with a first product; and
receive an addition from the user of a second website link associated with a second product, wherein the first product differs from the second product; and
the marketplace service being configured to:
perform an acquisition operation to extract a first set of information about the first product from the first website and a second set of information about the second product from the second website;
aggregate the first set of information and the second set of information; and
display the first set of information and the second set of information.

18. The system of claim 17, wherein the marketplace service being is further configured to:
receive, from the user, an addition of text or images associated with the first product or the second product; and
update the display of the first set of information and the second set of information based on the addition.

19. The system of claim 17, wherein the marketplace service being is further configured to:
update the first set of information and the second set of information in real-time.

20. The system of claim 19, wherein the first set of information and the second set of information includes a current stock status of the first product and the second product.
